(19) United States
(12) Patent Application Publication
(10) Pub. No.: US 2024/0380198 A1
(43) Pub. Date: Nov. 14, 2024

(54) INTRINSICALLY SAFE CIRCUIT FOR LOAD

(71) Applicant: ABB Schweiz AG, Baden (CH)

(72) Inventors: Wilfred Fernando Baluja, Metairie, LA (US); Chang Liu, Shanghai (CN)

(21) Appl. No.: 18/554,700

(22) PCT Filed: Aug. 4, 2021
(86) PCT No.: PCT/CN2021/110495

§ 371 Date: Oct. 10, 2023

(51) Int. Cl. H02H 11/00; G01F 23/22; H02H 9/02

(52) U.S. Cl. CPC H02H 11/00; G01F 23/22; H02H 9/02

(57) ABSTRACT

An intrinsically safe circuit includes energy input ports and energy output ports, and a first power line and a second power line connected in parallel between the energy input ports and energy output ports. The power lines are configured to deliver energy from the energy input ports to the energy output ports. The circuit can also include signal input ports and signal output ports, and a first signal line and a second signal line connected in parallel between the signal input ports and signal output ports. The signal lines are configured to deliver signals between the signal input ports and signal output ports. The circuit can also include a voltage clamping unit connected between the first power line, the second power line, the first signal line, and the second signal line. The circuit can also include a current limiting unit.

### FIELD

Embodiments of the present disclosure generally relate to the field of intrinsically safe circuits, and more particularly, to an intrinsically safe circuit for a load having a communication function.

### BACKGROUND

Intrinsically safe circuits are commonly used together with loads operating in explosive atmospheres to prevent explosion by limiting the energy in the sensor to a level below which can cause ignition by either sparking or heating effects. Conventional intrinsically safe circuits, such as intrinsically safe barriers, are usually only designed for an energy delivering channel. For loads comprising an energy delivering channel and a signal transmitting channel, such as those conforming to Modbus protocol, the conventional intrinsically safe circuits cannot limit the energy delivering in the signal transmitting channel or between the energy delivering channel and the signal transmitting channel. As a result, the conventional intrinsically safe circuits are no longer suitable for the loads having a communication function. Thus, there is a need for an intrinsically safe circuit that can limit the energy in a load comprising an energy delivering channel and a signal transmitting channel.

### SUMMARY

In view of the foregoing problems, various example embodiments of the present disclosure provide an intrinsically safe circuit for a load and a sensor circuit comprising the same to better limit the energy in a manner of high reliability and high safety.

In a first aspect of the present disclosure, example embodiments of the present disclosure provide an intrinsically safe circuit for a load. The intrinsically safe circuit comprises energy input ports and energy output ports; a first power line and a second power line connected in parallel between the energy input ports and energy output ports and configured to deliver energy from the energy input ports to the energy output ports; signal input ports and signal output ports; a first signal line and a second signal line connected in parallel between the signal input ports and signal output ports and configured to deliver signals between the signal input ports and signal output ports; a voltage clamping unit connected between the first power line, the second power line, the first signal line and the second signal line and configured to clamp a voltage between any two of the first power line, the second power line, the first signal line and the second signal line; and a current limiting unit connected in at least three of the first power line, the second power line, the first signal line and the second signal line, and configured to limit currents flowing through the first power line, the second power line, the first signal line and the second signal line. With these embodiments, the voltage and the current of the intrinsically safe circuit in a loop constituted by any two of the four lines are limited, such that the energy is limited to a predetermined energy level.

In some embodiments, the intrinsically safe circuit further comprises a voltage converter connected between the energy input ports and the first and second power lines and configured to adjust a voltage to be output by the intrinsically safe circuit. With these embodiments, a suitable voltage can be applied to the load.

In some embodiments, the voltage converter is a step-down converter. With these embodiments, the power is saved.

In some embodiments, the voltage clamping unit comprises a Zener diode. With these embodiments, the voltage clamping can be achieved at a low cost.

In some embodiments, the first power line is a positive voltage line, and the second power line is a negative voltage line; the voltage clamping unit comprises a first Zener diode, a second Zener diode, and a third Zener diode; an anode of the first Zener diode is connected to the second power line, and a cathode of the first Zener diode is connected to the first power line; an anode of the second Zener diode is connected to the second power line, and a cathode of the second Zener diode is connected to the first signal line; an anode of the third Zener diode is connected to the second power line, and a cathode of the third Zener diode is connected to the second signal line. With these embodiments, the use of the three Zener diodes may achieve a voltage clamping between any two lines.

In some embodiments, the current limiting unit comprises a fuse. With these embodiments, the current limiting can be achieved at a low cost.

In some embodiments, the intrinsically safe circuit further comprises a power line surge unit connected between a power supply and the energy input ports and configured to provide a surge protection for the first and second power lines. With these embodiments, the intrinsically safe circuit can achieve a better energy limiting effect.

In some embodiments, the intrinsically safe circuit further comprises a signal line surge unit connected between a signal source and the signal input ports and configured to provide a surge protection for the first and second signal lines. With these embodiments, the signal transmitting can be implemented reliably.

In some embodiments, the intrinsically safe circuit further comprises a communication unit connected to the energy output ports and the signal output ports and configured to exchange signals between the sensor and a signal source. With these embodiments, the energy and signals can be modulated before being delivered to the load.

In some embodiments, the communication unit comprises a Modbus device. With these embodiments, the Modbus protocol can be used in the load.

In a second aspect of the present disclosure, example embodiments of the present disclosure provide a sensor circuit. Wherein the sensor circuit comprises a flexible probe configured to measure a height of a liquid level; and an intrinsically safe circuit according to any of claims 1-10, the intrinsically safe circuit being electrically connected to the flexible probe and configured to supply energy to the flexible probe. The sensor circuit comprises the intrinsically safe circuit according to the first aspect of the present disclosure, thus may provide the same advantages.

In some embodiments, the flexible probe comprises a housing made of thermoplastic construction or flexible membranes. With these embodiments, the cost of material and installation of the sensor circuit can be reduced.

It is to be understood that the Summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in examples and in a non-limiting manner, wherein:

FIG. 1 is a schematic view illustrating a working scenario of a conventional intrinsically safe circuit;

FIG. 2 is a schematic block diagram of an intrinsically safe circuit in accordance with an embodiment of the present disclosure;

FIG. 3 is a schematic block diagram of an intrinsically safe circuit in accordance with another embodiment of the present disclosure; and

FIG. 4 is a schematic block diagram of a sensor circuit in accordance with an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to embodiments of the present disclosure, a voltage clamping unit and a current limiting unit are provided to any ports of the load so as to limit the energy output to the load. The above idea may be implemented in various manners, as will be described in detail in the following paragraphs.

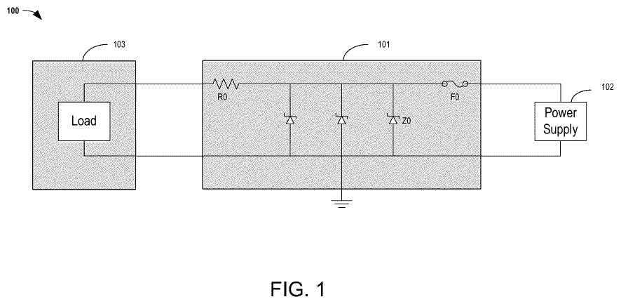

First, operational principles and problems of a conventional intrinsically safe circuit will be described in detail with reference to FIG. 1. FIG. 1 is a schematic view illustrating a working scenario of the conventional intrinsically safe circuit. As shown in FIG. 1, the intrinsically safe circuit is formed by an intrinsically safe barrier 101. The intrinsically safe barrier 101 is connected between a power supply 102 and a load 103 (such as, a sensor) to limit an energy delivered from the power supply 102 to the load 103.

As shown in FIG. 1, the intrinsically safe barrier 101 comprises a fuse F0, three Zener diodes Z0, and a resistor RO. The fuse F0 is used to prevent an overcurrent from flowing into the load 103 and the Zener diodes Z0 are used to clamp a voltage applied to the load 103. When the current exceeds a predetermined current level, the fuse F0 may be disconnected, and the current provided to the load 103 will become 0. When the voltage of the power supply 102 exceeds a predetermined voltage level, the Zener diodes Z0 are conducted, and the voltage applied to the load 103 may be clamped to a breakdown voltage of the Zener diodes Z0. By clamping the voltage and limiting the current, the energy delivered to the load 103 may be limited.

When the load 103 is a sensor having a communication function (for example, a sensor conforming to Modbus protocol), the load 103 usually comprises an energy delivering channel, a signal transmitting channel, and at least four ports. Two ports are used for energy delivering, and two ports are used for signal transmitting. Normally, the intrinsically safe barrier 101 is connected to the energy delivering ports of the sensor. However, due to the number of the ports being more than two, the intrinsically safe barrier 101 and the sensor may be misconnected. In some situations, there is no voltage clamping unit or current limiting unit. As a result, a situation of over-voltage or over-current may occur.

Thus, there is a need for an intrinsically safe circuit that can limit the energy in a load comprising an energy delivering channel and a signal transmitting channel, no matter how the load is connected to the intrinsically safe circuit.

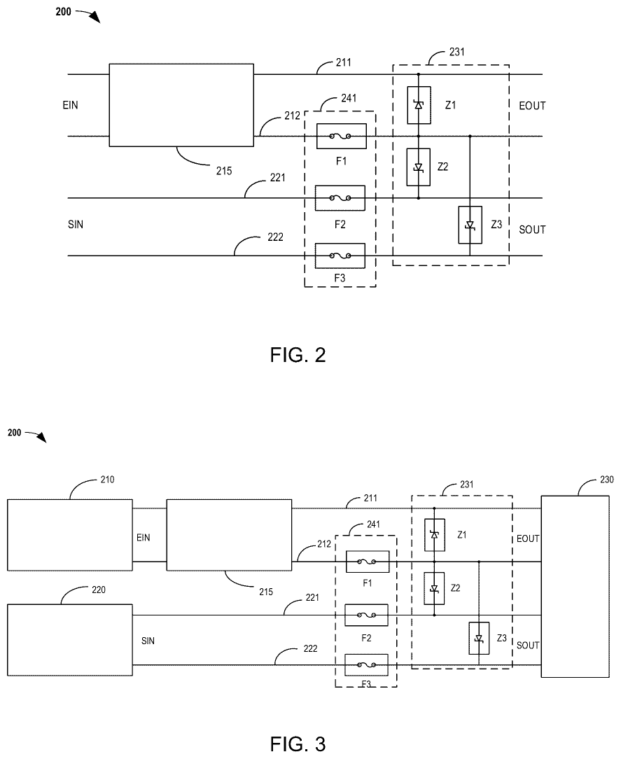

Hereinafter, the principles of the intrinsically safe circuit in accordance with embodiments of the present disclosure will be described in detail with reference to FIGS. 2-3. Refer to FIG. 2 first. FIG. 2 is a schematic block diagram of an intrinsically safe circuit in accordance with an embodiment of the present disclosure. As shown in FIG. 2, the intrinsically safe circuit 200 generally includes a first power line 211, a second power line 212, a first signal line 221, a second signal line 222, a voltage clamping unit 231 and a current limiting unit 241.

As shown in FIG. 2, the first power line 211 and the second power line 212 are connected in parallel between energy input ports EIN and energy output ports EOUT of the intrinsically safe circuit 200 to deliver energy from the energy input ports EIN to the energy output ports EOUT.

In some embodiments, the first power line 211 is a positive voltage line, and the second power line 212 is a negative voltage line. In other embodiments, the first power line 211 can be a negative voltage line, and the second power line 212 can be a positive voltage line. The scope of the present disclosure is not intended to be limited in this respect.

As shown in FIG. 2, the first signal line 221 and the second signal line 222 are connected in parallel between signal input ports SIN and signal output ports SOUT of the intrinsically safe circuit 200 to deliver signals between the signal input ports SIN and signal output ports SOUT.

In some embodiments, the first signal line 221 and the second signal line 222 are twisted-pair. In other embodiments, the first signal line 221 and the second signal line 222 can be other types of lines. The scope of the present disclosure is not intended to be limited in this respect.

As shown in FIG. 2, the voltage clamping unit 231 is connected between the first power line 211, the second power line 212, the first signal line 221 and the second signal line 222. The voltage clamping unit 231 is used to clamp a voltage between any two of the first power line 211, the second power line 212, the first signal line 221 and the second signal line 222.

In some embodiments, the voltage clamping unit 231 comprises a first Zener diode Z1, a second Zener diode Z2, and a third Zener diode Z3. An anode of the first Zener diode Z1 is connected to the second power line 212, and a cathode of the first Zener diode Z1 is connected to the first power line 211. An anode of the second Zener diode Z2 is connected to the second power line 212, and a cathode of the second Zener diode Z2 is connected to the first signal line 221. An anode of the third Zener diode Z3 is connected to the second power line 212, and a cathode of the third Zener diode Z3 is connected to the second signal line 222. In other embodiments, the voltage clamping unit 231 can include other components. The scope of the present disclosure is not intended to be limited in this respect.

In some embodiments, the breakdown voltage of the Zener diodes Z1-Z3 is 5V. In other embodiments, the breakdown voltage of the Zener diodes Z1-Z3 can be other values, for example, 10V, 24V. The scope of the present disclosure is not intended to be limited in this respect.

If a situation of over-voltage occurred between the first power line 211 and the second power line 212, the first Zener diode Z1 is reverse conducted, and the voltage applied to the load is clamped at the breakdown voltage of the first Zener diode Z1. If a situation of over-voltage occurred between the first power line 211 and the first signal line 221, the first Zener diode Z1 is reverse conducted, and the voltage applied to the load is clamped at a voltage equal to the breakdown voltage of the first Zener diode Z1 plus a forward voltage of the second Zener diode Z2. If a situation of over-voltage occurred between the first power line 211 and the second signal line 222, the first Zener diode Z1 is reverse conducted, and the voltage applied to the load is clamped at a voltage equal to the breakdown voltage of the first Zener diode Z1 plus a forward voltage of the third Zener diode Z3. If a situation of over-voltage occurred between the first signal line 221 and the first signal line 221, the second Zener diode Z2 is reverse conducted, and the voltage applied to the load is clamped at a voltage equal to the breakdown voltage of the second Zener diode Z2 plus the forward voltage of the third Zener diode Z3.

With the above arrangement, no matter how the load in connected to the intrinsically safe circuit 200, the voltage applied to the load can always be clamped when a situation of over-voltage occurs.

As shown in FIG. 2, the current limiting unit 241 is connected in at least three of the first power line 211, the second power line 212, the first signal line 221 and the second signal line 222. The current limiting unit 241 is used to limit currents flowing through the first power line 211, the second power line 212, the first signal line 221 and the second signal line 222.

In some embodiments, the current limiting unit 241 comprises three fuses F1, F2, and F3. The fuse F1 is connected in the second power line 212, the fuse F2 is connected in the first signal line 221, and the fuse F3 is connected in the second signal line 222. In other embodiments, the current limiting unit 241 can include other components. The scope of the present disclosure is not intended to be limited in this respect.

In some embodiments, the fusing current of the fuses Z1-Z3 is 28 mA. In other embodiments, the fusing current of the fuse can be of other values, for example, 26 mA, 30 mA. The scope of the present disclosure is not intended to be limited in this respect.

With the above arrangement, the currents flowing through any two of the first power line 211, the second power line 212, the first signal line 221 and the second signal line 222 are limited.

In some embodiments, the intrinsically safe circuit 200 further comprises a voltage converter 215. The voltage converter 215 is connected between the energy input ports EIN and the first and second power lines 211-212. The voltage converter 215 is used to provide a regulated voltage suitable for the load, for example, a sensor. Since the voltage is regulated, the chance that a situation of over-voltage occurs is significantly reduced.

In some embodiments, the voltage converter 215 is a step-down converter, and the output voltage of the step-down converter is about 4.5V. In other embodiments, the voltage converter 215 can be other types of converter, for example, a boost converter. The scope of the present disclosure is not intended to be limited in this respect.

With the intrinsically safe circuit as shown in FIG. 2, the current between any two of the power lines and the signal lines is limited, and the voltage applied to the sensor by any two of the power lines and the signal lines is clamped. As a result, the energy is well limited no matter how the load is connected to the energy limiting device.

FIG. 3 is a schematic block diagram of an intrinsically safe circuit in accordance with another embodiment of the present disclosure. As shown in FIG. 3, in addition to the voltage converter 215, the voltage clamping unit 231 and the current limiting unit 241, the intrinsically safe circuit 200 further comprises a power line surge unit 210, a signal line surge unit 220 and a communication unit 230.

The power line surge unit 210 is connected between a power supply and the energy input ports EIN and is used to provide a surge protection for the first and second power lines 211, 212. The power line surge unit 210 also can provide a voltage stabilizing function. The power line surge unit 210 can be any kind of surge devices.

The signal line surge unit 220 is connected between a signal source and the signal input ports SIN and is configured to provide a surge protection for the first and second signal lines 221, 222. The signal line surge unit 220 can provide a better signal transmitting. The signal line surge unit 220 can be any kind of surge devices.

The communication unit 230 is connected to the energy output ports EOUT and the signal output ports SOUT and used to exchange signals between the load and a signal source. In some embodiments, the communication unit 230 comprises a Modbus device. In other embodiments, the communication unit 230 may comprise other types of devices. The scope of the present disclosure is not intended to be limited in this respect.

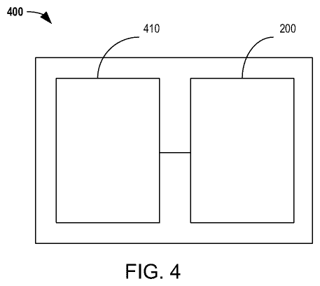

Hereinafter, the principles of a sensor circuit will be described in detail with reference to FIG. 4. FIG. 4 is a schematic block diagram of a sensor circuit in accordance with an embodiment of the present disclosure. As shown in FIG. 4, the sensor circuit 400 generally includes a flexible probe 410 and an intrinsically safe circuit 200 according to embodiments of the present disclosure.

As shown in FIG. 4, the intrinsically safe circuit 200 is electrically connected to the flexible probe 410 and used to supply energy to the flexible probe 410. The flexible probe 410 is used to measure a height of a liquid level, for example, gas. Different current value output by the flexible probe 410 indicates different height of the liquid level. In some embodiments, the flexible probe 410 comprises a housing made of thermoplastic construction or flexible membranes. In other embodiments, the flexible probe comprises other kinds of housings. The scope of the present disclosure is not intended to be limited in this respect.

With the sensor circuit as shown in FIG. 4, as the energy of the flexible probe 410 is well limited by the intrinsically safe circuit 200, the flexible probe 410 can be used in explosive atmospheres. Compared with the sensors carrying Explosion Proof (XP) or Flameproof (Exd) protection types, the sensor circuit 400 can reduce material and installation costs while meeting the requirement of Intrinsically Safe.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An intrinsically safe circuit for a load, comprising:
energy input ports and energy output ports;
a first power line and a second power line connected in parallel between the energy input ports and energy output ports and configured to deliver energy from the energy input ports to the energy output ports;
signal input ports and signal output ports;
a first signal line and a second signal line connected in parallel between the signal input ports and signal output ports and configured to deliver signals between the signal input ports and signal output ports;
a voltage clamping unit connected between the first power line, the second power line, the first signal line and the second signal line and configured to clamp a voltage between any two of the first power line, the second power line, the first signal line and the second signal line; and
a current limiting unit connected in at least three of the first power line, the second power line, the first signal line and the second signal line, and configured to limit currents flowing through the first power line, the second power line, the first signal line and the second signal line.

2. The intrinsically safe circuit according to claim 1, further comprising:
a voltage converter connected between the energy input ports and the first and second power lines and configured to adjust a voltage to be output by the intrinsically safe circuit.

3. The intrinsically safe circuit according to claim 2, wherein the voltage converter is a step-down converter.

4. The intrinsically safe circuit according to claim 1, wherein the voltage clamping unit comprises a Zener diode.

5. The intrinsically safe circuit according to claim 4, wherein the first power line is a positive voltage line, and the second power line is a negative voltage line;
the voltage clamping unit comprises a first Zener diode, a second Zener diode, and a third Zener diode;
an anode of the first Zener diode is connected to the second power line, and a cathode of the first Zener diode is connected to the first power line;
an anode of the second Zener diode is connected to the second power line, and a cathode of the second Zener diode is connected to the first signal line;
an anode of the third Zener diode is connected to the second power line, and a cathode of the third Zener diode is connected to the second signal line.

6. The intrinsically safe circuit according to claim 1, wherein the current limiting unit comprises a fuse.

7. The intrinsically safe circuit according to claim 1, further comprising:
a power line surge unit connected between a power supply and the energy input ports and configured to provide a surge protection for the first and second power lines.

8. The intrinsically safe circuit according to claim 1, further comprising:
a signal line surge unit connected between a signal source and the signal input ports and configured to provide a surge protection for the first and second signal lines.

9. The intrinsically safe circuit according to claim 1, further comprising:
a communication unit connected to the energy output ports and the signal output ports and configured to exchange signals between the load and a signal source.

10. The intrinsically safe circuit according to claim 9, wherein the communication unit comprises a Modbus device.

11. A sensor circuit comprising:
a flexible probe configured to measure a height of a liquid level; and
an intrinsically safe circuit according to claim 1, the intrinsically safe circuit being electrically connected to the flexible probe and configured to supply energy to the flexible probe.

12. The sensor circuit according to claim 11, wherein the flexible probe comprises a housing made of thermoplastic construction or flexible membranes.

13. The sensor circuit according to claim 11, wherein the intrinsically safe circuit further comprises:
a voltage converter connected between the energy input ports and the first and second power lines and configured to adjust a voltage to be output by the intrinsically safe circuit.

14. The sensor circuit according to claim 13, wherein the voltage converter is a step-down converter.

15. The sensor circuit according to claim 11, wherein the voltage clamping unit comprises a Zener diode.

16. The sensor circuit according to claim 15, wherein the first power line is a positive voltage line, and the second power line is a negative voltage line;
the voltage clamping unit comprises a first Zener diode, a second Zener diode, and a third Zener diode;
an anode of the first Zener diode is connected to the second power line, and a cathode of the first Zener diode is connected to the first power line;
an anode of the second Zener diode is connected to the second power line, and a cathode of the second Zener diode is connected to the first signal line;
an anode of the third Zener diode is connected to the second power line, and a cathode of the third Zener diode is connected to the second signal line.

17. The sensor circuit according to claim 11, wherein the current limiting unit comprises a fuse.

18. The sensor circuit according to claim 11, wherein the intrinsically safe circuit further comprises:
a power line surge unit connected between a power supply and the energy input ports and configured to provide a surge protection for the first and second power lines.

19. The sensor circuit according to claim 11, wherein the intrinsically safe circuit further comprises:
a signal line surge unit connected between a signal source and the signal input ports and configured to provide a surge protection for the first and second signal lines.

20. The sensor circuit according to claim 11, wherein the intrinsically safe circuit further comprises:
a communication unit connected to the energy output ports and the signal output ports and configured to exchange signals between the load and a signal source.
